(19) United States
(12) Patent Application Publication
(10) Pub. No.: US 2006/0227073 A1
(43) Pub. Date: Oct. 12, 2006

(54) Display apparatus and multi-display system

(75) Inventors: Akihiro Okano, Tokyo (JP); Hitoshi Kuriyama, Tokyo (JP); Takefumi Hama, Tokyo (JP)

Correspondence Address: NIXON & VANDERHYE, PC, 901 NORTH GLEBE ROAD, 11TH FLOOR, ARLINGTON, VA, 22203, US

(73) Assignee: PIONEER CORPORATION, Tokyo (JP)

(21) Appl. No.: 11/372,352

(22) Filed: Mar. 10, 2006

(30) Foreign Application Priority Data
Mar. 11, 2005 (JP) 2005-069580

(51) Int. Cl. G09G 3/28

(52) U.S. Cl. 345/60

(57) ABSTRACT

A CCD 14 is disposed on the rear of the discharge cell structures 13, and light introduced from the discharge cell structures 13 to the rear side, or light leaked from the discharge cell structures 13 to the rear side is measured by the CCD 14. Then, the light amount measurement result outputted from the CCD 14 is quantified, and on the basis of this, the brightness correction is automatically performed.

### BACKGROUND OF THE INVENTION

1. Field of the Invention

The present invention relates to a display apparatus having a self-emission structure, such as a plasma display apparatus, and a multi-display system which is provided with a plurality of display apparatuses describe above and in which one wide display area is formed by arranging the video image display areas of the display apparatuses.

2. Description of the Related Art

Currently, plasma display apparatuses are broadly spread as display devices for television. The plasma display apparatuses have self-emission structures each of which emits light by itself. Namely, a plasma display apparatus is provided with two electrodes, a plasma discharge space, and a fluorescent material, in each cell. The plasma display apparatus applies a voltage between the electrodes, to thereby produce a discharge in the plasma discharge space. Then, the plasma display apparatus irradiates the fluorescent material with ultraviolet light produced by this discharge, to thereby convert the ultraviolet light to visible light. By such a principle, the plasma display emits light by itself and displays video images.

On the other hand, the multi-display system is spread, as the display device of an information announcing apparatus for announcing information in streets, at stations, on playing fields, or the like. The multi-display system is provided with a plurality of plasma display apparatuses, for example, in which one wide display area is formed by arranging the video image display areas of the plasma display apparatuses in the same plane. For example, nine plasma display apparatuses are arranged in a matrix of 3×3, to thereby form one wide display area. According to the multi-display system, by displaying one video or image in the wide display area, the video or image can be greatly enlarged and displayed.

By the way, the plasma display apparatus has such a problem of image burn-in. In other words, the fluorescent material of the plasma display apparatus deteriorates, in accordance with an emission time length. Namely, as the emission time length increases, the fluorescent material deteriorates more. If the fluorescent material deteriorates, the brightness of an image formed by light emitted from the fluorescent material decreases. Thus, for example, if one static image is continuously displayed on the plasma display apparatus for a long time, only the fluorescent material which emits light for the display of the static image keeps deteriorating. As a result, the brightness decreases only in the portion where light is emitted for the display of the static image. By this, when another video or image which is different from the static image displayed for a long time is displayed on the plasma display apparatus, there arises a phenomenon that the trace of the static image displayed for a long time is left, i.e., a phenomenon of image burn-in. This type of burn-in is likely produced even on an EL (electroluminescence) display apparatus having the same self-emission structure as that of the plasma display apparatus.

On the other hand, in order to improve the quality of the image or video displayed in the wide display area of the multi-display system, it is desirable to equalize the brightness of a display image or display video among the plurality of plasma display apparatuses which constitute the multi-display system. Alternatively, it is desirable to make a continuous change in brightness of the display image or display video among the plurality of plasma display apparatuses. For example, if one of the plurality of plasma display apparatuses which constitute the multi-display system is replaced with a new plasma display apparatus, the brightness becomes ununiform and discontinuous between the plasma display apparatus which has been provided and the new plasma display apparatus. In particular, in the multi-display system in which the continuity of the video image display areas of adjacent plasma display apparatuses is improved by thinning the joints (outer frame portions) or eliminating the joints of the respective plasma display apparatuses, there is noticeable ununiformity and discontinuity of the brightness between the adjacent plasma display apparatuses. In this case, in the conventional multi-display system, brightness adjustment or color adjustment is performed in each plasma display apparatus in an effort to the uniformity or continuity of the brightness among the plasma display apparatuses. However, it is not easy to perform the operation of performing the brightness adjustment or color adjustment in each plasma display apparatus, and thus there is a problem that it requires skill. Moreover, even if a skillful personnel performs the adjustment, there is still a problem that it takes time to perform the adjustment.

### SUMMARY OF THE INVENTION

In order to solve the above-mentioned problem, it is therefore a first object of the present invention to provide a display apparatus and a multi-display system in which the trace by image burn-in can be eliminated.

It is a second object of the present invention to provide a display apparatus and a multi-display system which can facilitate the uniformity or continuity of brightness among a plurality of display apparatuses.

It is a third object of the present invention to provide a display apparatus and a multi-display system in which brightness adjustment can be performed, easily, highly accurately, or in a short time.

It is a fourth object of the present invention to provide a display apparatus and a multi-display system in which brightness adjustment can be automatically performed.

The above object of the present invention can be achieved by a display apparatus provided with: a front plate which is located on a front side that a video image display area is formed and which has optical transparency; a back plate which is located on a rear side and which has optical transparency; a self-emission structure which is located between the front plate and the back plate and which emits light by itself; and a light amount measuring device, which is located on a rear side of the self-emission structure, for measuring an amount of light emitted from the self-emission structure.

The above object of the present invention can be also achieved by a multi-display system which is provided with a plurality of display apparatuses and in which one wide display area is formed by arranging video image display areas of the plurality of display apparatuses, each display apparatus provided with: a front plate which is located on a front side that a video image display area is formed and which has optical transparency; a back plate which is located on a rear side and which has optical transparency; a self-emission structure which is located between the front plate and the back plate and which emits light by itself; and a light amount measuring device, which is located on a rear side of the self-emission structure, for measuring an amount of light emitted from the self-emission structure; a measurement result quantifying device for quantifying a measurement result outputted from the light amount measuring device and for providing it as a light amount measured value; an outputting device for outputting the light amount measured value provided from the measurement result quantifying device to another display apparatus; a receiving device for receiving the light amount measured value outputted from another display apparatus; an emission controlling device for controlling emission of the self-emission structure on the basis of an input video signal, to thereby display a video image in the video image display area; and a brightness correcting device for correcting brightness information included in the input video signal, on the basis of the light amount measured value provided from the measurement result quantifying device and the light amount measured value of the another display apparatus received from the receiving device.

### BRIEF DESCRIPTION OF THE DRAWINGS

FIG. 1 is a cross sectional view showing a first embodiment of the display apparatus of the present invention;

FIG. 2 is an explanatory diagram showing an arrangement relationship between discharge cell structures and CCDs in a parallel direction to a panel surface, in the first embodiment of the display apparatus of the present invention;

FIG. 3 is an explanatory diagram showing another example of the arrangement relationship between the discharge cell structures and the CCD s in the parallel direction to a panel surface;

FIG. 4 is an explanatory diagram showing another example of the arrangement relationship between the discharge cell structures and the CCD s in the parallel direction to a panel surface;

FIG. 5 is an explanatory diagram showing an arrangement example of the CCD in a video image display area;

FIG. 6 is a cross sectional view showing the operation of the display apparatus shown in FIG. 1;

FIG. 7 is a cross sectional view showing a second embodiment of the display apparatus of the present invention;

FIG. 8 is a block diagram showing a drive control unit of the display apparatus shown in FIG. 1;

FIG. 9 is a flowchart showing a correction value setting process of the display apparatus shown in FIG. 1;

FIG. 10 is an explanatory diagram showing an embodiment of the multi-display system of the present invention;

FIG. 11 is a block diagram showing a plasma display apparatus which constitutes the multi-display system shown in FIG. 10;

FIG. 12 is a flowchart showing a correction value setting process in the multi-display system shown in FIG. 10; and

FIG. 13 is an explanatory diagram showing one example of a correction value setting order in the correction value setting process shown in FIG. 12.

### DETAILED DESCRIPTION OF THE PREFERRED EMBODIMENTS

The embodiments of the present invention will be explained with reference to the drawings.

### First Embodiment of Display Apparatus

In the explanation below, an AC (Alternating Current) type and surface discharge type plasma display apparatus is given as the first embodiment of the display apparatus of the present invention. However, the present invention can be also applied to a DC (Direct Current) type plasma display apparatus. Moreover, the present invention can be also applied to a face-type or opposed type plasma display apparatus. Furthermore, the present invention can be also applied to another display apparatus having a self-emission structure. For example, the present invention can be also applied to an EL (Electro-Luminescence) display apparatus, a FED (Field Emission Display) apparatus, and a SED (Surface-conduction Electron-emitter Display) apparatus.

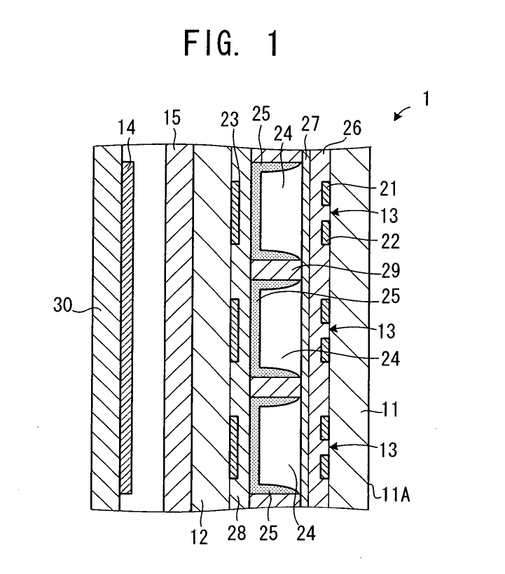

FIG. 1 is a cross sectional view showing one portion of the plasma display apparatus which is the first embodiment of the display apparatus of the present invention. As shown in FIG. 1, a plasma display apparatus 1 is provided with: a front plate 11; a back plate 12; discharge cell structures 13; CCDs (Charge Couple Devices) 14; and a light diffuser 15.

The front plate 11 has optical transparency. The front plate 11 is disposed on the front of the plasma display apparatus 1, i.e. on the side that the video image display area is formed. The front plate 11 is a glass substrate, for example. A surface located on the front of the front plate 11 is a panel surface 11A.

The back plate 12 has optical transparency. The back plate 12 is disposed on the rear of the plasma display apparatus 1. The front plate 11 is a glass substrate, for example.

The discharge cell structures 13 are disposed between the front plate 11 and the back plate 12. Each of the discharge cell structures 13 is provided with: two display electrodes 21 and 22; a data electrode 23; a plasma discharge space 24; and a fluorescent material 25. Each of the display electrodes 21 and 22 is a transparent electrode formed of ITO (Indium Tin Oxide), fore example. The display electrodes 21 and 22 are mounted on a surface located on the rear of the front plate, and are covered with a transparent dielectric layer 26 and a protective layer 27. The data electrode 23 is desirably a transparent electrode formed of ITO, for example. The data electrode 23 is mounted on a surface located on the front of the back plate 12, and is covered with a transparent dielectric layer 28. The plasma discharge space 24 is defined by the front plate 11, the back plate 12, and partitions 29 formed between the front plate 11 and the back plate 12. The fluorescent material 25 is applied to the surface of the transparent dielectric layer 28 facing the inside of the plasma discharge space 24, and the surface of the partition 29 facing the inside of the plasma discharge space 24. In the discharge cell structure 13, if a voltage is applied between the display electrodes 21 and 22 and the data electrode 23 or between the display electrode 21 and the display electrode 22 to thereby produce a discharge in the plasma discharge space 24, the fluorescent material is irradiated with ultraviolet light produced by this discharge, and by this, the fluorescent material emits visible light. This is how the discharge cell structures 13 emit light by themselves.

Incidentally, the discharge cell structure 13 is a specific example of the self-emission structure which emits light by itself. The construction of the self-emission structure is not limited to that shown in FIG. 1. If the self-emission structure is provided with: two electrodes; a plasma discharge space; and a fluorescent material, and a voltage is applied between the electrodes to produce a discharge in the plasma discharge space, and the fluorescent material is irradiated with ultraviolet light produced by this discharge to convert it to visible light, then, another structure can be adopted. Moreover, the self-emission structure is not limited to what uses the discharge principle of the plasma. The self-emission structure may be what is used in the EL display apparatus, and what is used in the FED apparatus or SED apparatus.

There are provided a plurality of discharge cell structures 13, and they are arranged in a matrix, for example, in a surface parallel to the panel surface 11A. The discharge cell structures 13 are what emits red light, what emits green light, and what emits blue light. These discharge cell structures 13 are arranged in the order of red, green, and blue, for example. In FIG. 1, the discharge cell structure 13 which emits red light, the discharge cell structure 13 which emits green light, and the discharge cell structure 13 which emits blue light are arranged from the upper side to the lower side of the figure. Incidentally, the color emitted from the discharge cell structure 13 is determined by the fluorescent material.

The CCD 14 measures the amount of light emitted from the discharge cell structures 13. The CCD 14 is mounted on the internal surface of a rear wall 30, located on the rear of the plasma display apparatus 1. Incidentally, the CCD 14 is a specific example of the light amount measuring device. The light amount measuring device is not limited to the CCD 14, and may be a semiconductor photo detector (e.g. a CMOS (Complementary Metal-Oxide-Semiconductor) device), such as a photo diode and a photo transistor. Moreover, the mounting position of the CCD 14 may be arbitrary if the CCD 14 is located on the rear of the discharge cell structures 13 (the self-emission structure) and can measure the amount of light emitted from the discharge cell structures.

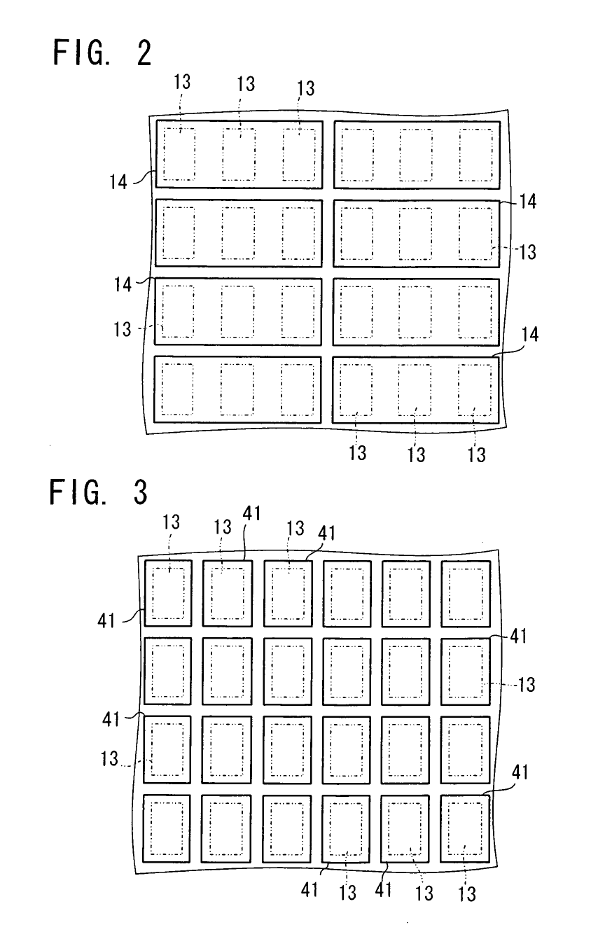

Moreover, in FIG. 1, one CCD 14 is provided for each set of the discharge cell structure 13 which emits red light, the discharge cell structure 13 which emits green light, and the discharge cell structure 13 which emits blue light. FIG. 2 is a perspective view showing the plasma display apparatus 1 in FIG. 1, as seen through the rear wall 30 from the rear of the apparatus 1. From FIG. 2, the arrangement relationship between the discharge cell structures 13 and the CCDs 14 in the direction parallel to the panel surface 11A can be seen. The red light, the green light and the blue light can be combined to produce white light. By providing one CCD 14 for each set of the three discharge cell structure 13 which emit red light, green light and blue light, the amount of the white light can be measured by the CCDs 14. This facilitates the measurement of the amount of light, and also, it is possible to use inexpensive CCD elements.

Incidentally, the arrangement relationship between the discharge cell structures 13 (the self-emission structure) and the CCDs 14 (the light amount measuring device) in the direction parallel to the panel surface 11A is not limited to this. For example, as shown in FIG. 3, there may be provided a plurality of CCDs 41 wherein one CCD 41 is provided for each of the plurality of discharge cell structures 13. By this, it is possible to measure the amount of light emitted from the discharge cell structure 13 in each color. Therefore, it is possible to realize highly accurate brightness correction by using the light amount measurement result in each color.

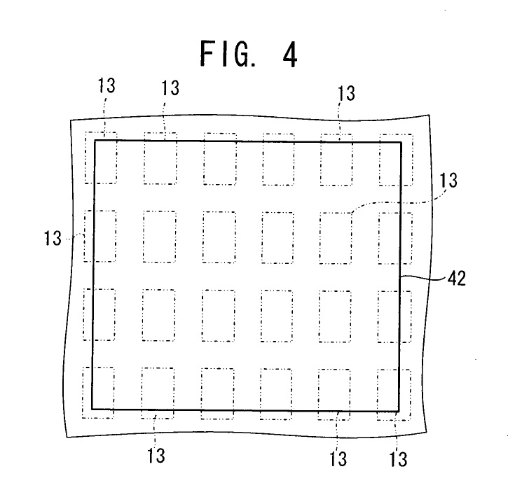

Moreover, the plurality of discharge cell structures 13 may be divided into a plurality of groups, and one CCD may be provided for each of the plurality of groups. For example, as shown in FIG. 4, all the discharge cell structures 13 provided for the plasma display apparatus 1 may be divided into a plurality of groups, each of which has 24 discharge cell structures 13, and one CCD 42 may be provided for each of the plurality of groups. Moreover, all the discharge cell structures 13 provided for the plasma display apparatus 1 may be divided into a plurality of groups, each of which has 65536 discharge cell structures 13 in a matrix of 256 rows and 256 columns, and one CCD may be provided for each of the plurality of groups.

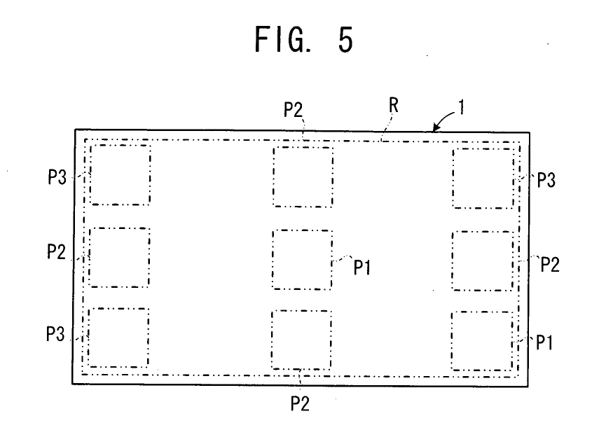

Moreover, the CCD 14 may be provided such that it corresponds to all the discharge cell structures 13. For example, as shown in FIG. 2, if one CCD 14 is provided for each set of the three discharge cell structures 13, all the discharge cell structures 13 of the plasma display apparatus 1 may be divided into a plurality of groups, each of which has three discharge cell structures 13 in red, green, and blue, and the CCD 14 may be provided for each of all the sets. However, the CCD 14 may not be provided in accordance with all the discharge cell structures 13. For example, as shown in FIG. 5, it is possible to provide the CCD 14 only in a position P1 corresponding to the center of a video image display area R of the plasma display apparatus 1, positions P2 near the edges of the video image display area R, and positions P3 near the corners of the video image display area R. Moreover, the CCD 14 may be provided only in the position P1 and the positions P2. Alternatively, the CCD 14 may be provided only in the position P1 and the positions P3.

Back in FIG. 1, the light diffuser 15 diffuses light emitted from the discharge cell structures 13. The light diffuser 15 is disposed between the discharge cell structures 13 and the CCD 14. Specifically, the light diffuser 15 is mounted on a surface located on the rear of the back plate 12, for example. The light diffuser 15 is desirably provided with a lens mechanism, such as a micro lens. The light diffuser 15 diffuses each of the red light, the green light, and the blue light emitted from the respective three discharge cell structures 13, and focuses the white light which is formed by combining the three colored light, on the CCD 14. Incidentally, the light diffuser 15 is a specific example of the diffusing device. Moreover, as shown in FIG. 3, if one CCD 14 is provided for one discharge cell structure 13 to measure the amount of light in each color, the light diffuser 15 (the diffusing device) may be eliminated.

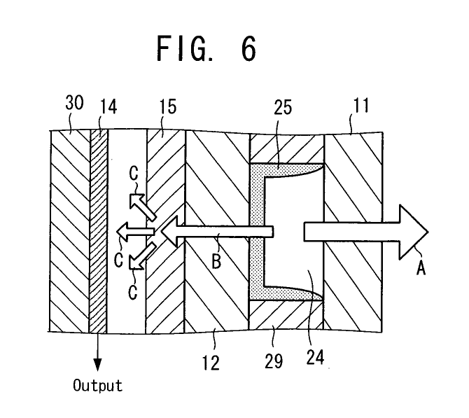

FIG. 6 shows the light amount measurement operation of the display apparatus 1. Incidentally, FIG. 6 shows one of the three discharge cell structures 13 in FIG. 1 and its surrounding portion. For convenience of explanation, the illustration of the electrodes, the dielectric layer, and the protective layer or the like of the discharge cell structure 13 is omitted. As shown in FIG. 6, in the discharge cell structure 13, if a discharge is produced in the plasma discharge space 24, ultraviolet light produced by this discharge is converted to visible light by the fluorescent material 25. Most part of the visible light is outputted to the front of the plasma display apparatus 1, as shown by a thick arrow A in FIG. 6. However, a part of the visible light is outputted to the rear of the plasma display apparatus 1, as shown by a thin arrow B in FIG. 6. Hereinafter, the visible light outputted to the rear of the plasma display apparatus 1 is referred to “light to be measured”. The “light to be measured” passes through the back plate 12 having optical transparency, as shown by the arrow B. Then, the light to be measured is diffused in the light diffuser 15, as shown by arrows C, for example. Then, the diffused light to be measured is combined with light to be measured, which is emitted from another cell structure adjacent to the relevant discharge cell structure 13, and is focused on the CCD 14 by the lens mechanism of the light diffuser 15. Then, the CCD 14 measures the light to be measured. Namely, the CCD 14 performs photoelectric conversion on the basis of the light to be measured, generates an electrical signal corresponding to the amount of the light to be measured, and outputs it.

Incidentally, in the plasma display apparatus 1, as shown in FIG. 1, a path that the light to be measured can pass through is formed from the plasma discharge space 24 to the CCD 14, by forming the dielectric layer 28, the data electrode 23, and the back plate 12 by using transparent members. However, if the light is obtained to the extent that the amount of light can be measured by the CCD 14, the light to be measured may be leaked light from the plasma discharge space 24. In other words, if the amount of light can be measured from the leaked light from the plasma discharge space 24, it is unnecessary to specially form the optical path to let in the light to be measured.

As explained above, the plasma display apparatus 1 is provided with the CCD 14 for measuring the amount of light emitted from the discharge cell structures 13, on the rear of the discharge cell structures 13. By this, it is possible to measure the amount of light emitted from the discharge cell structures 13, and quantify or digitize the measurement result. Then, by using the measurement result or a numerical value which indicates the measurement result, it is possible to correct the brightness of the plasma display apparatus 1, easily, highly accurately, and in a short time. Therefore, if there is image burn-in in the video image display area of the plasma display apparatus 1, it is possible to easily eliminate the image burn-in by correcting the brightness. On the other hand, in the case of a multi-display system provided with a plurality of plasma display apparatuses 1, by using the measurement result of the amount of light obtained by the CCD 14, or the numerical value which indicates the measurement result, it is possible to realize the uniformity or continuity of the brightness among the plasma display apparatuses, easily, highly accurately, and in a short time.

### Second Embodiment of Display Apparatus

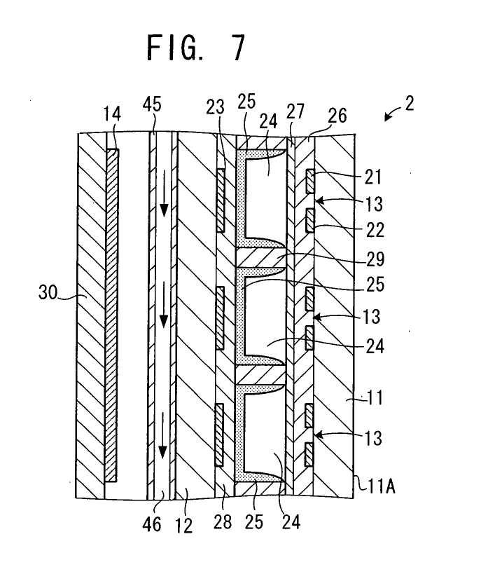

FIG. 7 is a cross sectional view showing one portion of a plasma display apparatus which is a second embodiment of the display apparatus of the present invention. Incidentally, the same constitutional elements as those of the plasma display apparatus 1 shown in FIG. 1 carry the same numerical references, and the explanation thereof is omitted. As shown in FIG. 7, there is provided a light diffuser 45 for diffusing light emitted from the discharge cell structures 13, between the back plate 12 and the CCD 14 in a plasma display apparatus 2. The light diffuser 45 is formed of a material having optical transparency. Moreover, the material to form the light diffuser 45 is desirably excellent in heat conduction.

Moreover, the light diffuser 45 has a path 46 therein to flow liquid or fluid. The liquid flowing in the path 46 is desirably milky-white liquid. By flowing the milky-white liquid in the path 46, the optical transparency decreases, and this causes the light diffuser 45 and transmitted light to be diffused. Namely, when the light to be measured emitted from the discharge cell structures 13 passes through the light diffuser 45 and is inputted to the CCD 14, it is diffused by the milky-white liquid which flows in the path 46.

Moreover, the liquid flowing in the path 46 has a function of absorbing heat produced from the discharge cell structures 13 or the like. Namely, the liquid flowing in the path 46 functions as cooling liquid. For example, the plasma display apparatus 2 may be provided with a pump and a radiator. The liquid may be circulated by the pump on the rear of the plasma display apparatus 2, and the heat may be released in the liquid by the radiator.

As explained above, according to the plasma display apparatus 2, it is possible to cool down the plasma display apparatus 2, in addition to the same effect as that of the plasma display apparatus 1.

(Brightness Correction of Display Apparatus)

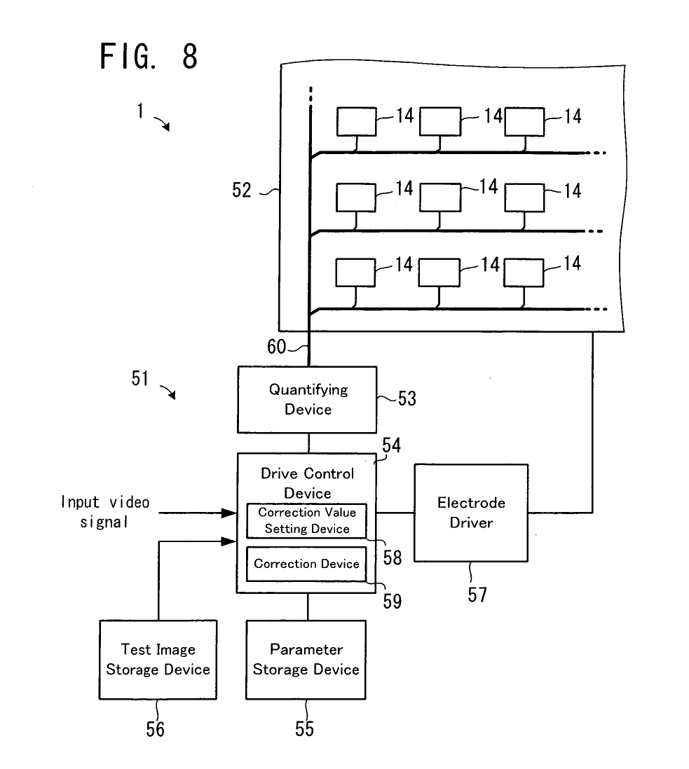

FIG. 8 shows a drive control unit provided for the plasma display apparatus 1. A drive control unit 51 in FIG. 8 controls the drive of the plasma display apparatus 1. Namely, the drive control unit 51 controls discharge and light emission in each discharge cell structure 13, on the basis of an input video signal, and by this, it displaces a video image corresponding to the input video signal in the video image display area of the plasma display apparatus 1. If a portion provided with the front plate 11, the back plate 12, the discharge cell structures 13, the CCDs 14, and the light diffuser 15 is referred to as a panel device 52, the drive control unit 51 is disposed on the outer edge or the rear of the panel portion 52.

As shown in FIG. 8, the drive control unit 51 is provided with a quantifying device 53; a drive control device 54; a parameter storage device 55; a test image storage device 56; and an electrode driver 57.

The quantifying device 53 quantifies the light amount measurement result outputted from the plurality of CCDs 14 mounted in the panel device 52. Namely, in the panel device 52, as shown in FIG. 1 and FIG. 2, one CCD 14 is provided for each set of the three discharge cell structures 13 which emit red light, green light, and blue light. Each CCD 14 is connected to the quantifying device 53 through a signal line 60. Each CCD 14 outputs an electrical signal corresponding to the amount of the measured light. The electrical signal outputted from each CCD 14 is supplied to the quantifying device 53 through the signal line 60. The quantifying device 53 receives the electrical signal outputted from each CCD 14 and quantifies the signal. For example, if the voltage of the electrical signal outputted from each CCD 14 corresponds to the amount of light measured by each CCD 14, the qualifying device 53 generates a numerical value corresponding to the voltage of the electrical signal outputted from each CCD 14 (hereinafter referred to as a “light amount measured value”). Moreover, the quantifying device 53 generates the light amount measured value, by performing an operation in view of characteristics of the CCD 14, characteristics of the light diffuser 15, emission characteristics of each emitted color (RGB) and visual characteristics of a human being. The light amount measured value is a binary digital value, for example. As described above, one CCD 14 is provided for each set of the three discharge cell structures 13 which emit red light, green light, and blue light, so that the light amount measured value is also generated for each set of the three discharge cell structures 13 which emit red light, green light, and blue light. The quantifying device 53 can be realized by an operation processing circuit and a semiconductor memory or the like, for example. Incidentally, the quantifying device 53 is a specific example of the measurement result quantifying device.

The drive control device 54 controls the electrode driver 57 in order to display the video image corresponding to the input video signal in the video image display area of the plasma display apparatus 1. Namely, the drive control device 54 generates a control signal for controlling the electrode driver 57, on the basis of the input video signal, and outputs it to the electrode driver 57. Moreover, in a correction value setting process, if a test image signal is inputted to the drive control device 54 from the test image storage device 56, the drive control device 54 generates a control signal for controlling the electrode driver 57, on the basis of the test image signal, and outputs it to the electrode driver 57, in order to display a test image corresponding to the test image signal in the video image display area. The drive control device 54 can be realized by an operation processing circuit and a semiconductor memory or the like, for example.

The drive control device 54 is provided with: a correction value setting device 58; and a correction device 59. The correction value setting device 58 and the correction device 59 have a function of correcting brightness information which is included in the input video signal, on the basis of the light amount measurement result (light amount measured value) which is outputted from each CCD 14 and which is quantified by the quantifying device 53.

The correction value setting device 58 sets a correction value for correcting the brightness information included in the input video signal, in the correction value setting process. The correction value setting process is a process of setting a correction value for correcting the brightness information included in the input video signal. In other words, as an emission time length becomes longer, the amount of light emitted from the discharge cell structures 13 decreases due to the deterioration of the fluorescent material 25 or the like. Then, the emission time length normally varies depending on the discharge cell structures 13. Thus, although an image signal having the same brightness information is given to each discharge cell structure 13, the brightness of images is not uniform in the discharge cell structures 13. In order to eliminate the ununiformity of the brightness, the brightness information included in the input video signal is corrected. For example, the correction is performed to improve the brightness in a portion corresponding to the discharge cell structure 13 with low brightness, out of the brightness information of the input video signal. The correction value setting device 58 sets a correction value for such correction. In the correction value setting process, the correction value setting device 58 sets the correction value on the basis of the light amount measured value. The light amount measured value is generated for each set of the three discharge cell structures 13 which emit red light, green light, and blue light. Thus, the correction value is also generated for each set of the three discharge cell structures 13 which emit red light, green light, and blue light. The correction value setting process is performed, immediately after the power of the plasma display apparatus 1 is on; when a user gives an instruction to perform the brightness correction; or in a certain cycle from the start of the plasma display apparatus 1. The test image stored in the test image storage device 56 is used for the correction value setting process. The detailed content of the correction value setting process will be described later.

The correction device 59 uses the correction value set in the correction value setting process, to thereby correct the brightness information included in the input video signal. The correction is performed for each set of the three discharge cell structures 13 which emit red light, green light, and blue light.

The parameter storage device 55 stores therein the correction value set in the correction value setting process. The correction value setting device 58 stores the generated correction value into the parameter storage device 55. The correction device 59 reads the correction value stored in the parameter storage device 55 and performs the correction. The parameter storage device 55 can be realized by a storage element, such as a semiconductor memory, or a storage medium, such as a hard disk. Incidentally, the parameter storage device 55, the correction value setting device 58, and the correction device 59 are a specific example of the brightness correcting device.

The test image storage device 56 stores therein test image data. The test image storage device 56 outputs the test image data to the drive control device 54 as the test image signal, in the correction value setting process. The test image storage device 56 can be realized by a storage element, such as a semiconductor memory, or a storage medium, such as a hard disk.

The electrode drive 57 generates a drive pulse signal for controlling discharge and light emission of each discharge cell structure 13, on the basis of the control signal outputted from the drive control device 54. The generated drive pulse signal is supplied to electrodes 21, 22, and 23 of the discharge cell structure 13. The electrode driver 57 can be realized by an oscillator, a signal processing circuit, a storage element, other electronic circuits and electric circuits. Incidentally, as shown in FIG. 1, the discharge cell structure 13 is provided with the three electrodes 21, 22, and 23 in total. In this case, the electrode driver 57 has respective driver circuits corresponding to the three electrodes 21, 22, and 23, and each driver circuit is mounted on the outer frame portion of the panel device. Moreover, the specific structure and mounting of each driver circuit are omitted in FIG. 8. Incidentally, the drive control device 54 and the electrode driver 57 are a specific example of the emission controlling device.

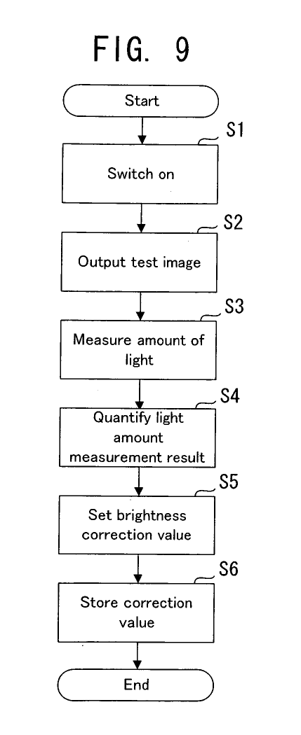

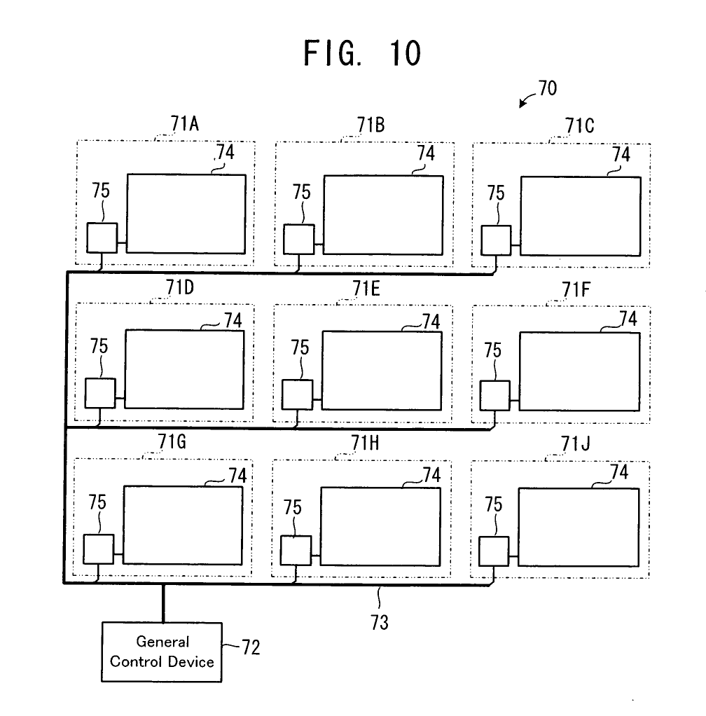

FIG. 9 shows the correction value setting process. As shown in FIG. 9, a user switches on the plasma display apparatus 1 (step S1). At first, the test image signal is outputted from the test image storage device 56 (step S2). Then, the correction value setting device 58 receives the test image signal. Then, the correction value setting device 58 reads the correction value from the parameter storage device 55. Immediately after the power is on, the correction values previously set in the correction value setting process are stored into the parameter storage device 55, and the correction value setting device 58 reads these correction values. Then, the correction value setting device 58 uses the read correction values and corrects the brightness information included in the test image signal. Then, the drive control device 54 generates the control signal for controlling the electrode driver 57, on the basis of the test image signal with the brightness information corrected, and outputs it to the electrode driver 57. Then, the electrode driver 57 generates the drive pulse signal for controlling discharge and light emission of each discharge cell structure 13 on the basis of the control signal, and supplies it to the electrodes 21, 22, and 23 of the discharge cell structure 13. By this, discharge and light emission are produced in each discharge cell structure 13, in accordance with the test image, and as a result, the test image is displayed in the video image display area of the plasma display apparatus 1. Then, each CCD 14 measures the amount of the light to be measured, emitted from each set of the discharge cell structures 13 (the three discharge cell structures 13 of red light, green light, and blue light), during the test image display (step S3). Then, each CCD 14 outputs the light amount measurement result to the quantifying device 53. The quantifying device 53 quantifies or digitizes the light amount measurement result outputted from each CCD 14, and generates the light amount measured value (step S4). Then, the correction value setting device 58 sets the correction value, on the basis of the light amount measured value (step S5). For example, the reference value of the amount of light corresponding to the test image may be stored in advance, and the reference value may be compared with the measured light amount value. The value with a difference of zero in the both values may be the correction value. The correction value set in this manner is stored into the parameter storage device 55 (step S6). Then, the correction value setting process is ended.

After that, if the video image is displayed by the plasma display apparatus 1, the correction device 59 uses the correction value stored in the parameter storage device 55 and corrects the brightness information included in the input video signal. By this, the ununiformity of the brightness of the image caused by the deterioration of the fluorescent material 25 or the like is eliminated.

As explained above, the drive control unit 51 quantifies the light amount measurement result outputted from each CCD 14, sets the correction value of the brightness on the basis of this, and corrects the input video signal by using the correction value. By this, it is possible to eliminate the ununiformity of the brightness of the image caused by the deterioration of the fluorescent material 25 or the like, easily, highly accurately, and in a short time. Moreover, it is also possible to automatically eliminate the ununiformity of the brightness.

(Multi-Display System)

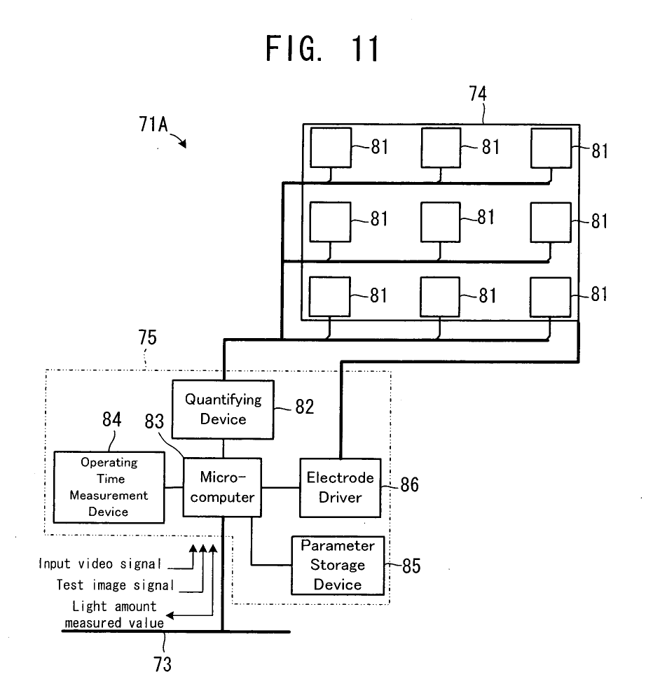

FIG. 10 shows an embodiment of the multi-display system of the present invention. As shown in FIG. 10, a multi-display system 70 is provided with nine plasma display apparatuses 71A to 71J, and one wide display area is formed by arranging the video image display areas of the plasma display apparatuses 71A to 71J in a matrix. The multi-display system 70 can display one video or image in one wide display area. Namely, one video or image can be divided into nine portions which are upper left, upper middle, upper right, middle left, center, middle right, lower left, lower middle, and lower right. Then, the divided video portions are assigned to the respective nine plasma display apparatuses 71A to 71J, and the video portions can be mutually synchronized and displayed. Moreover, the multi-display system 70 is provided with a function of automatically providing the uniformity or continuity of the brightness among the plasma display apparatuses 71A to 71J. Incidentally, the number and arrangement of the plasma display apparatuses are not limited in the multi-display system of the present invention. Moreover, each of the display apparatuses which constitute the multi-display system of the present invention is not limited to the plasma display apparatuses, and may be the EL display apparatus, the FED apparatus or SED apparatus.

As shown in FIG. 10, the multi-display system 70 is provided with a general control device 72 in addition to the nine plasma display apparatuses 71A to 71J. Each of the plasma display apparatuses 71A to 71J and the general control device 72 are connected to each other through a bus 73.

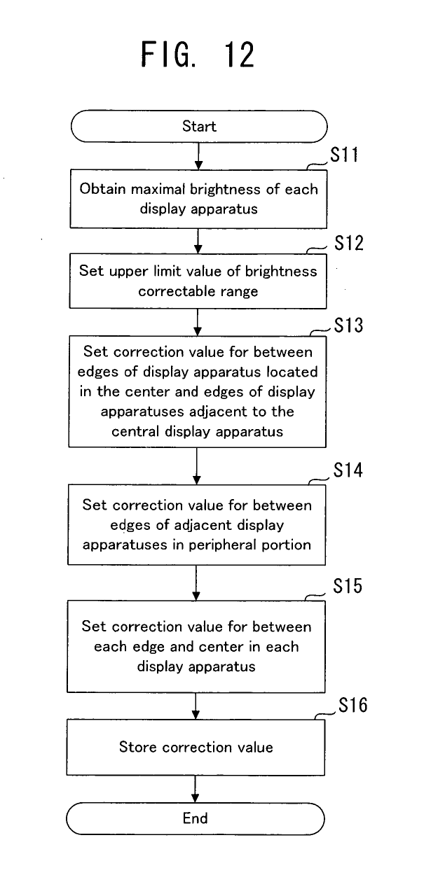

FIG. 11 shows the plasma display apparatus 71A. As shown in FIG. 11, the plasma display apparatus 71A is provided with: a panel device 74; and a drive control unit 75.

The panel device 74 is provided with: a front plate; a back plate; and discharge cell structures (all of which are not illustrated), substantially in the same manner as the panel device of the plasma display apparatus 1 shown in FIG. 1.

Moreover, the panel device 74 is provided with CCDs 81. Each of the CCDs 81 is disposed on the rear of the discharge cell structures, and measures the amount of light emitted from the discharge cell structures, substantially in the same manner as the CCD 14 of the plasma display apparatus 1 shown in FIG. 1. However, the arrangement relationship between the CCDs 81 and the discharge cell structures in the direction parallel to the panel surface is different from that of the plasma display apparatus 1 shown in FIG. 1. Namely, in the panel device 74, one CCD 81 is provided for 256×256=65536 discharge cell structures in total, for example. Moreover, in the panel device 74, as shown in FIG. 11, there are provided nine CCDs 81, and they are disposed in positions corresponding to the center, near the edges, and near the corners of the video image display area of the panel device 74. Namely, the CCD 81 is disposed in each of the center, upper edge, lower edge, left edge, right edge, upper left corner, upper right corner, lower left corner, and lower right corner. Incidentally, there is no limitation in the arrangement relationship between the CCDs and the discharge cell structures in the direction parallel to the panel surface. Moreover, the number of CCDs is not limited, either. Moreover, there is also no limitation in the arrangement of the CCDs (the center, near the edges, near the corners, etc.) in the direction parallel to the panel surface. However, in an effort to the uniformity or continuity of the brightness on the edges or corners of the video image display areas of two adjacent display apparatuses in the multi-display system (i.e. near the boundary of the two adjacent display apparatuses), it is preferable to dispose the CCDs in the positions near the edges or near the corners of the video image display area. Moreover, in an effort to the uniformity or continuity of the brightness between the edges or corners and the center of the video image display area of each display apparatus, it is preferable to dispose the CCD in the position corresponding to the center of the video image display area. Furthermore, in order to correct the uniformity of the brightness in each display apparatus, highly accurately, the CCDs may be provided without any space such that they can correspond to the entire video image display area of each display apparatus. However, in an effort to the uniformity or continuity of the brightness among the plasma display apparatuses in the multi-display system, it is unnecessary to provide the CCDs such that they can correspond to the entire video image display area of each display apparatus. It is only necessary to provide the CCD in a portion with noticeable ununiformity and discontinuity of the brightness, i.e., in the positions near the edges or near the corners (i.e. near the boundary) of the video image display area of each display apparatus, and further, provide the CCD in a position near the center of the video image display area of each display apparatus.

Moreover, the panel device 74 is provided with light diffusers (not illustrated). The light diffuser is disposed between the discharge cell structures and the CCD, and diffuses the light emitted from the discharge cell structures, substantially in the same manner as that of the plasma display apparatus 1 shown in FIG. 1. However, the number of light diffusers and the arrangements of the light diffusers in the direction parallel to the panel surface are different from those of the plasma display apparatus 1 shown in FIG. 1. For example, the number of light diffusers in the panel device 74 is the same as the number of CCDs 81, and the light diffusers are disposed in associated with the CCDs 81.

The drive control unit 75 controls the drive of the plasma display apparatus 71A. Namely, the drive control unit 75 controls discharge and light emission of each discharge cell structure, on the basis of an input video signal, and by this, it displays the video image corresponding to the input video signal in the video image display area of the panel device 74. The drive control unit 75 is mounted on the outer edge or on the rear of the panel device 74. As shown in FIG. 11, the drive control unit 75 is provided with: a quantifying device 82; a microcomputer 83; a operating time measurement device 84; a parameter storage device 85; and an electrode driver 86.

The quantifying device 82 quantifies the light amount measurement result outputted from the nine CCDs 81 mounted in the panel device 74, and generate a light amount measured value for each CCD 81. The structure of the quantifying device 82 or the like is substantially the same as that of the quantifying device 53 shown in FIG. 8.

The microcomputer 83 has a drive control function, a correction value setting function, a correction function and a communication function.

The drive control function of the microcomputer 83 is a function of controlling the electrode driver 86 to display the video image corresponding to the input video signal in the video image display area of the panel device 74. Namely, the microcomputer 83 generates a control signal for controlling the electrode driver 86 on the basis of the input video signal, and outputs it to the electrode driver 86.

The correction value setting function and the correction function of the microcomputer 83 are functions of correcting the brightness information included in the input video signal or test image signal, on the basis of the light amount measurement result (the light amount measured value) which is outputted from each CCD 81 and which is quantified by the quantifying device 82. To explain it specifically, the correction value setting function is a function of setting a correction value for correcting the brightness information included in the input video signal, in the correction value setting process. The correction function is a function of correcting the brightness information included in the input video signal, by using the correction value set in the correction value setting process. The correction value setting function and the correction function are substantially the same as those of the correction value setting device 58 and the correction device 59 shown in FIG. 8, respectively. However, in the correction value setting function of the microcomputer 83, for example, the correction value about positions near the edges, near the corners and the center of the video image display area of the panel device 74, i.e. only the correction value about the position where the CCD 81 is disposed, is set. Moreover, in the correction value setting function of the microcomputer 83, the correction value is set on the basis of the light amount measured value provided from another plasma display apparatus,. in addition to the light amount measured value generated by each CCD 81 and the quantifying device 83 of the plasma display apparatus 71A. Moreover, in the correction value setting function of the microcomputer 83, the correction value is set not only on the basis of the light amount measured value, but also on the basis of the operating time length of the panel device 74 or the emission deterioration characteristics of the fluorescent material, or the like.

The communication function of the microcomputer 83 is a function of outputting the light amount measured value generated by the quantifying deice 82 to another plasma display apparatus, and a function of receiving the light amount measured value outputted from another plasma display apparatus. By virtue of the communication function, the plasma display apparatuses 71A to 71J and the general control device 72 disposed in the multi-display system 70 can communicate with each other through the bus 73. Specifically, the plasma display apparatuses 71A to 71J and the general control device 72 can transmit and receive the light amount measured value and other information, through the bus 73. Moreover, the general control device 72 can supply the input video signal or test image signal, to each of the plasma display apparatuses 71A to 71J, through the bus 73.

The operating time measurement device 84 measures the operating time length of the panel device 74 and provides a operating time value which indicates the measurement result. The operating time measurement device 84 can be realized by a timer or the like, for example.

The parameter storage device 85 stores therein the correction value set in the correction value setting process, the operating time value measured by the operating time measurement device 84, the emission deterioration characteristics of the fluorescent material, information which indicates the arrangement of the plasma display apparatus in the wide display area (e.g. information which indicates that the plasma display apparatus 71A is disposed in the upper left of the wide display area). The parameter storage device 85 can be realized by a storage element, such as a semiconductor memory, and a storage medium, such as a hard disk.

The electrode driver 86 generates a drive pulse signal for controlling discharge and light emission of each discharge cell structure, on the basis of the control signal outputted from the microcomputer 83. The generated drive pulse signal is supplied to each electrode of each discharge cell structure. The electrode driver 86 can be realized by an oscillator, a signal processing circuit, a storage element, other electronic circuits and electric circuits.

The plasma display apparatuses 71B to 71J also have the same structure as that of the plasma display apparatus 71A.

On the other hand, the general control device 72 performs overall control and overall management of the plasma display apparatuses 71A to 71J. Specifically, the general control device 72 supplies the input video signal or test image signal, to each of the plasma display apparatuses 71A to 71J. Moreover, the general control device 72 controls the transmission and reception of the light amount measured value and other information among two adjacent plasma display apparatuses. Moreover, the general control device 72 totally controls the correction value setting process and the correction process about the brightness. Furthermore, the general control device 72 performs the video division process and the video synchronization process for displaying one video image in the wide display area. The general control device 72 can be realized by an operation processing circuit, a storage apparatus, or the like. Incidentally, the microcomputer 83 and the general control device 72 are a specific example of the emission controlling device, the brightness correcting device, the outputting device, and the receiving device.

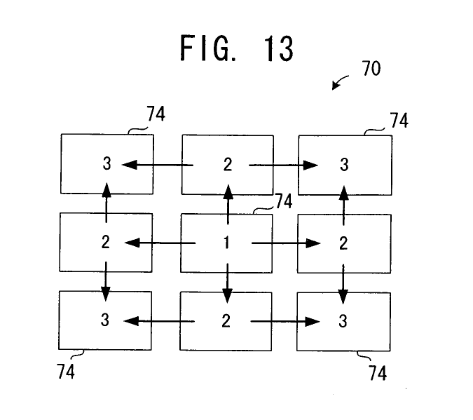

FIG. 12 shows the correction value setting process in the multi-display system 70. The correction value setting process is a process of setting a correction value for correcting the brightness information included in the input video signal. By using the correction value set in the correction value setting process, it is possible to automatically provide the uniformity or continuity of the brightness among the plasma display apparatuses 71A to 71J.

As shown in FIG. 12, if the power is on in the multi-display system 70, for example, the general control device 72 examines the maximal brightness value of each of the plasma display apparatuses 71A to 71J (step S11). For example, the general control device 72 supplies a test image signal for maximal brightness measurement to each of the plasma display apparatuses 71A to 71J, and displays this test image in the video image display area of each of the plasma display apparatuses 71A to 71J. The test image is an entirely white image, to display the entire video image display area of the plasma display apparatus in maximal brightness. By this, all the discharge cell structures of each of the plasma display apparatuses 71A to 71J emit light in maximal brightness. Then, each of the plasma display apparatuses 71A to 71J measures the amount of light when the light is emitted in maximal brightness from the CCD, and the light amount measured value corresponding to the light amount measurement result to the general control device 72.

Then, the general control device 72 compares the light amount measured values outputted from the plasma display apparatuses 71A to 71J with each other, and finds out the lowest value from them. Then, the general control device 72 sets this value as the upper limit value of a brightness correctable range in the correction value setting process (i.e. the upper limit value of the brightness after the correction) (step S12).

Then, under the control of the general control device 72, the microcomputers of the plasma display apparatuses 71B, 71D, 71E, 71F, and 71H set the correction value for the uniformity or continuity of the brightness, between the upper edge, lower edge, left edge, and right edge of the video image display area of the plasma display apparatus 71E located in the center of the wide display area, and the edges of the display video areas of the other plasma display apparatuses 71B, 71D, 71F, and 71H adjacent to the above-mentioned four edges of the apparatus 71E (step S13). Namely, the microcomputers of the plasma display apparatuses 71E and 71B set the correction value for correcting the brightness information of the input video signal corresponding to the video image displayed in the upper edge of the video image display area of the plasma display apparatus 71E, and the correction value for correcting the brightness information of the input video signal corresponding to the video image displayed in the lower edge of the video image display area of the plasma display apparatus 71B, in order to make uniform or continuous brightness between the upper edge of the video image display area of the plasma display apparatus 71E and the lower edge of the video image display area of the plasma display apparatus 71B. In the same manner, the microcomputers of the plasma display apparatuses 71E and 71H set the correction value about the lower edge of the video image display area of the plasma display apparatus 71E and the upper edge of the video image display area of the plasma display apparatus 71H. In the same manner, the microcomputers of the plasma display apparatuses 71E and 71D set the correction value about the left edge of the video image display area of the plasma display apparatus 71E and the right edge of the video image display area of the plasma display apparatus 71D. In the same manner, the microcomputers of the plasma display apparatuses 71E and 71F set the correction value about the right edge of the video image display area of the plasma display apparatus 71E and the left edge of the video image display area of the plasma display apparatus 71F.

At this time, it is preferable to fix the brightness in the upper edge, lower edge, left edge, and right edge of the video image display area of the plasma display apparatus 71E located in the center of the wide display area, and set each correction value to match the above-mentioned brightness with the brightness in the lower edge of the video image display area of the plasma display apparatus 71B, the upper edge of the video image display area of the plasma display apparatus 71H, the left edge of the video image display area of the plasma display apparatus 71D, and the right edge of the video image display area of the plasma display apparatus 71F, respectively. To explain it specifically, when the correction value is set for the upper edge of the video image display area of the plasma display apparatus 71E and the lower edge of the video image display area of the plasma display apparatus 71B, the setting is performed as follows. At first, the general control device 72 displays the test image in the video image display area of the plasma display apparatus 71E and the video image display area of the plasma display apparatus 71B. Then, in the plasma display apparatus 71E, the CCD disposed in the position corresponding to the upper edge of the video image display area measures the amount of light emitted from the discharge cell structure disposed in the position corresponding to the upper edge of the video image display area, and outputs the result to the quantifying device. Then, the quantifying device quantifies the light amount measurement result and generates a light amount measured value ml. Simultaneously, in the plasma display apparatus 71B, the CCD disposed in the position corresponding to the lower edge of the video image display area measures the amount of light emitted from the discharge cell structure disposed in the position corresponding to the lower edge of the video image display area, and outputs the result to the quantifying device. Then, the quantifying device quantifies the light amount measurement result and generates a light amount measured value m2. Then, the microcomputer 83 of the plasma display apparatus 71E transmits the light amount measured value m1 to the microcomputer 83 of the plasma display apparatus 71B. Then, the microcomputer 83 of the plasma display apparatus 71B receives the light amount measured value m1. Then, the microcomputer of the plasma display apparatus 71B calculates a difference d1 between the light amount measured value m1 and the light amount measured value m2. If m1 is greater than m2, the microcomputer of the plasma display apparatus 71B sets a correction value to increase m2 by d1. If m1 is less than m2, the microcomputer sets a correction value to reduce m2 by d1. Incidentally, practically, the correction value is preferably set, not only in view of the difference in the amount of light, but also in view of the operating time length of the panel device 74 or the emission deterioration characteristics of the fluorescent material or the like.

Then, under the control of the general control device 72, the microcomputers of the plasma display apparatuses 71A, 72B, 71C, 71D, 71F, 71G, 71H, and 71J set the correction value for the uniformity or continuity of the brightness in the edges of the video image display areas of the adjacent plasma display apparatuses, with respect to the plasma display apparatuses 71A, 72B, 71C, 71D, 71F, 71G, 71H, and 71J located in the peripheral portion of the wide display area (step S14). Namely, the microcomputers of the plasma display apparatuses 71A and 72B set the correction value for correcting the brightness information of the input video signal corresponding to the video image displayed in the left edge of the video image display area of the plasma display apparatus 71B, and the correction value for correcting the brightness information of the input video signal corresponding to the video image displayed in the right edge of the video image display area of the plasma display apparatus 71A, in order to make uniform or continuous brightness between the left edge of the video image display area of the plasma display apparatus 71B and the right edge of the video image display area of the plasma display apparatus 71A. In the same manner, the microcomputers of the plasma display apparatuses 71B and 71C set the correction value about the right edge of the video image display area of the plasma display apparatus 71B and the left edge of the video image display area of the plasma display apparatus 71C. In the same manner, the microcomputers of the plasma display apparatuses 71H and 71G set the correction value about the left edge of the video image display area of the plasma display apparatus 71H and the right edge of the video image display area of the plasma display apparatus 71G. In the same manner, the microcomputers of the plasma display apparatuses 71H and 71J set the correction value about the right edge of the video image display area of the plasma display apparatus 71H and the left edge of the video image display area of the plasma display apparatus 71J. In the same manner, the microcomputers of the plasma display apparatuses 71A and 71D set the correction value about the upper edge of the video image display area of the plasma display apparatus 71D and the lower edge of the video image display area of the plasma display apparatus 71A. In the same manner, the microcomputers of the plasma display apparatuses 71D and 71G set the correction value about the lower edge of the video image display area of the plasma display apparatus 71D and the upper edge of the video image display area of the plasma display apparatus 71G. In the same manner, the microcomputers of the plasma display apparatuses 71C and 71F set the correction value about the upper edge of the video image display area of the plasma display apparatus 71F and the lower edge of the video image display area of the plasma display apparatus 71C. In the same manner, the microcomputers of the plasma display apparatuses 71F and 71J set the correction value about the lower edge of the video image display area of the plasma display apparatus 71F and the upper edge of the video image display area of the plasma display apparatus 71J.

At this time, it is preferable to fix the brightness in the edges of the plasma display apparatuses 71B, 71H, 71D, and 71F, relatively closely located in the center of the wide display area, and set each correction value to respectively match the above-mentioned brightness with the brightness in the edges of the plasma display apparatuses 71A, 71C, 71G, and 71J, relatively distantly located in the center of the wide display area. To explain it specifically, when the correction value is set for the left edge of the video image display area of the plasma display apparatus 71B and the right edge of the video image display area of the plasma display apparatus 71A, the setting is performed as follows. At first, the general control device 72 displays the test image in the video image display area of the plasma display apparatus 71B and the video image display area of the plasma display apparatus 71A. Then, in the plasma display apparatus 71B, the CCD disposed in the position corresponding to the left edge of the video image display area measures the amount of light emitted from the discharge cell structure disposed in the position corresponding to the left edge of the video image display area, and outputs the result to the quantifying device. Then, the quantifying device quantifies the light amount measurement result and generates a light amount measured value m3. Simultaneously, in the plasma display apparatus 71A, the CCD disposed in the position corresponding to the right edge of the video image display area measures the amount of light emitted from the discharge cell structure disposed in the position corresponding to the right edge of the video image display area, and outputs the result to the quantifying device. Then, the quantifying device quantifies the light amount measurement result and generates a light amount measured value m4. Then, the microcomputer 83 of the plasma display apparatus 71B transmits the light amount measured value m3 to the microcomputer 83 of the plasma display apparatus 71A. Then, the microcomputer 83 of the plasma display apparatus 71A receives the light amount measured value m3. Then, the microcomputer of the plasma display apparatus 71A calculates a difference d2 between the light amount measured value m3 and the light amount measured value m4. If m3 is greater than m4, the microcomputer of the plasma display apparatus 71A sets a correction value to increase m4 by d2. If m3 is less than m4, the microcomputer sets a correction value to reduce m4 by d2. Incidentally, practically, the correction value is preferably set, not only in view of the difference in the amount of light, but also in view of the operating time length of the panel device 74 or the emission deterioration characteristics of the fluorescent material or the like.

Then, the general control device 72 sets the correction value for the uniformity or continuity of the brightness between each edge and the center, in each of the plasma display apparatuses 71A to 71J (step S15). For example, the general control device 72 sets the correction value for correcting the brightness information of the input video signal corresponding to the video image displayed in or around the center (i.e. a place other than the peripheral portion) of the video image display area of the plasma display apparatus 71E, such that the brightness in the upper edge, lower edge, left edge, and right edge is equal to the brightness in the center, in the plasma display apparatus 71E located in the center of the wide display area, or such that there is a continuous change in the brightness between each of the edges and the center.

The correction value set in the above-mentioned process is stored into the parameter storage device 85 (step S16). Then, the correction value setting process is ended.

FIG. 13 shows the order of setting the correction value in the correction value setting process shown in FIG. 12. As shown in FIG. 13, the correction value setting of the correction value in the correction value setting process is preferably performed from the center to the periphery of the wide display area. Namely, at first, the brightness of the edges of the plasma display apparatus 71E located in the center is fixed, and the brightness of the edges of the plasma display apparatuses 71B, 71H, 71D; and 71F is matched with the fixed brightness. Then, the brightness of the edges of the plasma display apparatuses 71B, 71H, 71D, and 71F is fixed, and the brightness of the edges of the plasma display apparatuses 71A, 71C, 71G, and 71J is desirably matched with the fixed brightness.

After the correction value setting process, when the video image is displayed by the multi-display system 70, the microcomputer 83 of each of the plasma display apparatuses 71A to 71J uses the correction value stored in the parameter storage device 85 and corrects the brightness information included in the input video signal, under the control of the general control device 72. By this, it is possible to realize the uniformity or continuity of the brightness of the image displayed in the video image display area of each of the plasma display apparatuses 71A to 71J which constitute the wide display area of the multi-display system 70. In particular, it is possible to realize the uniformity or continuity of the brightness near the boundary of the two adjacent display apparatuses.

As explained above, the multi-display system 70 quantifies the light amount measurement result outputted from each CCD 14 provided for each of the plasma display apparatuses 71A to 71J, to thereby generate the light amount measured value. Moreover, the multi-display system 70 transmits and receives the light amount measured value among the plasma display apparatuses 71A to 71J, to thereby realize the uniformity or continuity of the brightness among the plasma display apparatuses 71A to 71J. By this, it is possible to provide the uniformity or continuity of the brightness among the plasma display apparatuses 71A to 71J, easily, highly accurately, and in a short time. It is also possible to automate the correction process in an effort to the uniformity or continuity of the brightness among the plasma display apparatuses 71A to 71J, to thereby reduce the correction operation of the brightness in the multi-display system. Furthermore, it is possible to omit the correction operation, by virtue of complete automation of the correction process.

The invention may be embodied in other specific forms without departing from the spirit or essential characteristics thereof The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2005-069580 filed on Mar. 11, 2005 including the specification, claims, drawings and summary is incorporated herein by reference in its entirety.

What is claimed is:

1. A display apparatus comprising:
a front plate which is located on a front side that a video image display area is formed and which has optical transparency;
a back plate which is located on a rear side and which has optical transparency;
a self-emission structure which is located between said front plate and said back plate and which emits light by itself; and
a light amount measuring device, which is located on a rear side of said self-emission structure, for measuring an amount of light emitted from said self-emission structure.

2. The display apparatus according to claim 1, further comprising a diffusing device, which is located between said self-emission structure and said light amount measuring device, for diffusing the light emitted from said self-emission structure.

3. The display apparatus according to claim 1, wherein the display apparatus has a plurality of self-emission structures, and one light amount measuring device is provided for each of the plurality of self-emission structures.

4. The display apparatus according to claim 1, wherein the display apparatus has a plurality of self-emission structures, the plurality of self-emission structures are divided into a plurality of groups, and one light amount measuring device is provided for each of the plurality of groups.

5. The display apparatus according to claim 1, wherein the display apparatus has a plurality of self-emission structures, the plurality of self-emission structures include a first self-emission structure which emits red light, a second self-emission structure which emits green light and a third self-emission structure which emits blue light, and one light amount measuring device is provided for a set of the first self-emission structure, the second self-emission structure and the third self-emission structure.

6. The display apparatus according to claim 1, wherein said light amount measuring device is disposed in a position substantially corresponding to a center of the video image display area.

7. The display apparatus according to claim 1, wherein said light amount measuring device is disposed near an edge of the video image display area.

8. The display apparatus according to claim 1, wherein said light amount measuring device is disposed near a corner of the video image display area.

9. The display apparatus according to claim 2, wherein said diffusing device is made of a material having optical transparency and has. a path therein to flow liquid.

10. The display apparatus according to claim 1, further comprising a measurement result quantifying device for quantifying a measurement result outputted from said light amount measuring device.

11. The display apparatus according to claim 1, further comprising:
an emission controlling device for controlling emission of said self-emission structure on the basis of an input video signal, to thereby display a video image in the video image display area; and
a brightness correcting device for correcting brightness information included in the input video signal, on the basis of a measurement result outputted from said light amount measuring device.

12. The display apparatus according to claim 1, wherein said self-emission structure comprises two electrodes, a plasma discharge space and a fluorescent material, applies a voltage between the electrodes to thereby produce a discharge in the plasma discharge space, and irradiates the fluorescent material with ultraviolet light produced by this discharge to thereby convert the ultraviolet light to visible light.

13. The display apparatus according to claim 1, wherein said light amount measuring device comprises a semiconductor photo detector.

14. The display apparatus according to claim 1, wherein said light amount measuring device comprises a CCD.

15. The display apparatus according to claim 2, wherein said diffusing device comprises a lens.

16. A multi-display system which comprises a plurality of display apparatuses and in which one wide display area is formed by arranging video image display areas of the plurality of display apparatuses, each display apparatus comprising:
a front plate which is located on a front side that the video image display area is formed and which has optical transparency;
a back plate which is located on a rear side and which has optical transparency;
a self-emission structure which is located between said front plate and said back plate and which emits light by itself; and
a light amount measuring device, which is located on a rear side of said self-emission structure, for measuring an amount of light emitted from said self-emission structure;
a measurement result quantifying device for quantifying a measurement result outputted from said light amount measuring device and for providing the quantified measurement result as a light amount measured value;
an outputting device for outputting the light amount measured value provided from said measurement result quantifying device to another display apparatus;
a receiving device for receiving the light amount measured value outputted from another display apparatus;
an emission controlling device for controlling emission of said self-emission structure on the basis of an input video signal, to thereby display a video image in the video image display area; and
a brightness correcting device for correcting brightness information included in the input video signal, on the basis of the light amount measured value provided from said measurement result quantifying device and the light amount measured value of the another display apparatus received from said receiving device.
